(19) United States
(12) Patent Application Publication
(10) Pub. No.: US 2005/0227047 A1
(43) Pub. Date: Oct. 13, 2005

(54) Method for producing temperature-regulating surfaces with phase change material

(76) Inventors: Simon Sutter, Chur (CH); Roland Lottenbach, Zeig (CH)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/477,531

(22) PCT Filed: May 7, 2002
(86) PCT No.: PCT/CH02/00245

§ 371 Date: Nov. 12, 2003

(30) Foreign Application Priority Data
May 18, 2001 (CH) 933/01

(51) Int. Cl. B32B 5/02; B32B 3/00; B32B 9/00

(52) U.S. Cl. 428/195.1; 442/59; 428/196; 428/197; 101/217; 427/412; 427/416

(57) ABSTRACT

There is proposed a process for the preparation of a temperature regulating surface and/or structures on a substrate. With the novel process a stencil print preferably on textile surfaces is proposed, wherein the print is in particular designed in the form of nubs, which contain a high concentration of a temperature regulating material, preferably paraffin. By the accumulation of the temperature regulating material in the form of a plurality of nubs the elasticity and the breathability and the possibility of a vapor and moisture exchange of the substrate is maintained to a great extent. Furthermore, there are proposed products, preferably textile articles, onto which the temperature regulating surfaces have been applied by means of the proposed process.

### BACKGROUND OF THE INVENTION

1. Field of the Invention

The invention relates to a process for the preparation of temperature controlling surfaces and/or structures on a substrate and products onto which a temperature regulating surface and/or structure has been applied using said process.

2. Prior Art

Temperature regulating surfaces are generally known. Preferably, they contain phase change material, also called PCM. For example, a suitable PCM consists of paraffin. When energy is supplied or dissipated to the PCM in the range of its melting temperature it maintains in this temperature until the phase transition from solid to liquid state of aggregation (or vice versa) is completed or until the whole mass took on its new state of aggregation. Only after the completion of said phase transition, the temperature will adequately increase or decrease upon a continued supply or dissipation of energy. This effect is used to control temperatures, in particular to protect articles or bodies from heat or cold or to maintain constant a particular temperature of an article or body.

In textile finishing a plurality of PCM is employed, wherein from the printed publications U.S. Pat. No. 5,366,801, U.S. Pat. No. 5,804,297 and U.S. Pat. No. 5,804,297 a microencapsulated PCM with a polymeric binder is known, in which the preparation of the microencapsulated PCM may be relatively expensive. Another form is represented by non-encapsulated PCM, which is used in a form bound to a structure. Polymeric binders with both forms of PCM are preferably used in a wash-resistant form.

Each temperature regulating surface is applied to a textile material by means of a coating. Such coating methods are well known in the textile industry, in particular in textile finishing.

To obtain a sufficiently large effect of a long lasting temperature control, an appropriate thermal capacity and thus an appropriate amount of PCM has to be applied. This leads to a higher coating thickness or to a higher concentration of the PCM within the coating. Both a higher coating thickness and a higher concentration negatively affect the wearing comfort since the stiffness is increased and the breathability is reduced. Specifically in connection with semipermeable functional layers, this is a serious disadvantage since a combination of both functions—temperature control as well as breathability—is desirable.

### SUMMARY OF THE PRESENT INVENTION

The object of the invention is the development of a process which applies temperature regulating surfaces and/or structures with a sufficient amount of PCM to a substrate wherein simultaneously the elastic properties of the substrate as well as a breathability and vapor and moisture exchange of the surface is maintained to a great extent. Furthermore, it is a basis of the invention to provide products having temperature regulating surfaces containing a sufficient amount of PCM and in which the elastic properties as well as breathability of the substrate and the vapor and moisture exchange of the surface are maintained to a great extent.

A further object of the invention is to increase the insulating effect of the substrate with the temperature regulating surface and to minimize the preparation and material costs as well as the weight of the materials applied in the surface.

The object with respect to the preparation is solved by a printing method according to claim 1 and the product of the present invention by the features of claim 31.

There is proposed a process for the preparation of a temperature regulating surface and/or structures on a substrate. With the novel process a stencil print preferably on textile surfaces is proposed, wherein the print is in particular designed in the form of nubs, which contain a high concentration of a temperature regulating material, preferably paraffin. By the accumulation of the temperature regulating material in the form of a plurality of nubs the elasticity and the breathability and the possibility of a vapor and moisture exchange of the substrate is maintained to a great extent. Furthermore, there are proposed products, preferably textile articles, onto which the temperature regulating surfaces have been applied by means of the proposed process.

### DETAILED DESCRIPTION OF THE PRESENT INVENTION

The advantage of an application by means of a printing method resides in the possibility to apply the print preferably only partially. For the thus obtained surface areas of the substrate which have not been printed the original properties, in particular elasticity, breathability and the ability to ensure vapor and moisture exchange, remain in an advantageous manner.

To apply a sufficiently large amount of PCM to the substrate the printed areas are preferably formed with nubs. This is achieved by using stencils having a wall thickness in the order of 0.6 to 4 mm, preferably 0.6 to 2 mm and an open areas of at least 25%, preferably of at least 35%.

Preferably, as a phase change material or PCM a crystallizing organic substance, e.g. an n-paraffin having a melting point between −10 and 65° C. (n-docadene to n-octacosane) is used. The paraffin may be introduced into a polymeric dispersion in a form bound to a porous structure or in microencapsulated form.

PCM may for example be bound to a porous silicate powder with high specific surface. The thus obtained composite contains up to 60% of PCM and has the form of a powder capable of flowing. As an encapsulating material for the PCM containing microcapsules melamine resin proved successful since it does not swell, such as e.g. gelatin. The solvent of the polymeric dispersion may be alcohols, however water is used preferably. The water content of the wet polymeric dispersion should be between 20 and 60%, preferably between 25 and 40%. In particular, it is advantageous if the polymer used is skin forming, cold-, heat- or UV-light-crosslinkable, elastic, cold-resistant, wash-resistant and resistant to dry cleaning.

The PCM containing microcapsules are added to the aqueous dispersion slowly under constant stirring. The PCM containing microcapsules are wetted more rapid by further addition of a dispersant. If the viscosity increases by the addition of the PCM containing microcapsules despite the presence of a dispersant, such that the paste can no longer be stirred, the water content has to be increased. On the other hand, the viscosity of the dispersion should be in the range of 80 to 180 dPa·s, preferably 120 to 160 dPa·s (according to Hacke, test spindle 1) so as to avoid any segregation. If this value is not yet achieved by the addition of PCM microcapsules, a thickening agent is further added. The binder may be in the form of monomers, oligomers or low molecular weight polymers which are polymerized or crosslinked during the drying and or plastification process. The admixture of crosslinking agents is only necessary if the binder systems are not self-crosslinking at higher temperatures. Warrn crosslinking agents as well as cold crosslinking agents are suitable. Further additions, such as dies, bacteriostatics, flame retardants or flavours may be admixed, if required. If the print has to be foamed to increase the volume of the print, an expanding agent is additionally added. The dry content of the final polymer dispersion should contain between 30 and 80% of PCM. An example of a polymeric dispersion is given in Table 1.

TABLE 1
Composition of the polymeric dispersion:

| 1000 parts | polymeric binder | e.g. Dicrylan AS |
|---|---|---|
| | in solution or | binder, e.g. acrylates, |
| | in aqueous | polyurethanes, latices, or |
| | dispersion | silicones, or blends or |
| | | copolymerisates of said |
| | | polymers |
| 200 to 2000 parts | PCM in a bound | |
| | or micro- | |
| | encapsulated | |
| | form | |
| 0 to 40 parts | dispersant | e.g. Invadine PBN or |
| | or emulsifier | Rapidoprint HL |
| 0 to 30 parts | thickening agent | e.g. Dicrylan R |
| | ammonia for raising the pH-value | |
| 0 to 30 parts | crosslinking | warm crosslinker on the basis |
| | agent | of melamine resin, e.g. Lyofix |
| | | CHN |
| | | cold crosslinker on the basis of |
| | | isocyanate, e.g. Tubigard Fix |
| optionally 20 | expanding agent | e.g. Mikroprint E-46, |
| to 100 parts | | Polyacoating |

| | |
|---|---|
| optionally | dies, bacteriostatics, dampness inhibitors, flavours |

As a substrate any printable surface is useful, in particular a surface in the form of a metal sheet, a metal film or foil, a plastic sheet or film, of a foamed material or preferably a textile surface is used. Elastic textile fabrics, in particular consisting of a texture, a knitted fabric, or a nonwoven fabric have been found to be very useful. Further studies revealed that it might be advantageous if the textile surface has previously been finished with hydrophobic properties. On the one hand, the soft hand of the textile surface is retained by this since the fabric does not absorb the aqueous dispersion, on the other hand the hydrophobicity finishing of a textile substrate prevents that a water separation layer is formed during printing with aqueous dispersions which may lead to problems with adhesion of the print.

According to the present invention, a stencil printing carried out by means of rotational stencils or flat stencils is used for the print. To achieve the required high application weight of 200 to 500 g/m² dry substance of the polymeric dispersion with the print, a fine adjustment of the paste viscosity with respect to the blade pressure and to the substrate spacing is required considering the stencil geometry. The stencil surface pressure is not or only indirectly important for the determination of the weight of the application. The PCM applied to the substrate by means of the printing should be at least 80 g/m², preferably 100 to 300 g/m².

Subsequently, the newly printed substrate is transferred through a drying device to remove the solvent, e.g. the water. The higher the solid content of the PCM containing dispersion, the less time and energy is required for drying. If temperature activated warm crosslinkers are used or if the binding system is a self-crosslinking binding system a reaction temperature of typically 120 to 150° C. has to be achieved in the drying facility. If UV-crosslinkers are used, the print is irradiated subsequent to drying to initiate the reaction. If an expanding agent is used for foaming it should also be activated under the selected drying or condensation conditions, so that the print is crosslinked in the desired final thickness.

Furthermore, there is the possibility to use the polymeric dispersion simultaneously as an adhesive for a lamination. In this case a cover layer, e.g. a texture, a knitted fabric or a nonwoven fabric is layered on the still wet print prior to the passage through the drying facility.

Following the passage through the drying facility the print is sufficiently plastified that the substrate may be rolled or stacked without the motive being smeared, blurred or destroyed, or the product unintentionally adheres or a foamed print is again pressed flat.

The advantage of said process is that thus relatively large amounts of PCM for the long lasting effect of the temperature control may be stored, without essentially reducing the elasticity of the printed substrate. This is achieved by the accumulation of large amounts of PCM in the nubs. The non-printed region of the substrate, i.e. the interval between the nubs remains its elasticity and simultaneously the breathability as well as the vapor and moisture permeability. Thus, the substrate is less stiffened as with a full surface coating and remains the desired softness. Since the individual nubs are not connected to each other they don't act in a stiffening manner. In total, the PCM portion relative to the binder may thus be increased and the product ensures a better ratio of the PCM mass to the entire thickness, to the entire weight and to the preparation and material costs.

Another positive effect of this method is the better insulating effect of the substrate with the print, in particular if this is formed in nubs and if another cover layer has been applied onto the nubs. The air enclosed between the layers and the nubs contributes to the insulation of the product, without incorporating additional weight by insulating materials into the product and thus without the expenditure of additional production and material costs.

A further advantage of the process is the possibility to only partly apply the print to selected sites. For example, the print is partly applied according to printing contours of a pattern for a manufacture of garmets. The advantage of this application is not only in weight and cost savings due to the prevention of an application of a print to a surface of a substrate which will not be used, it is of further advantage for the manufacture of garmets. At seams and hems there is no additional thickness of a second printing layer. This is also positive for the final manufactured garmets which have a coating of uniform thickness in particular also in the seam and fold areas.

Further preferred possibilities of the print are obtained by a regionally different cover layer of the print or the nubs, respectively, on the substrate. In areas of clothes having partially different requirements to elasticity, breathability, water vapor flow resistance and/or to the PCM ratio, a partially different print with respect to nub height, ratio of printed and non-printed areas and concentration of PCM in the dispersion is applied. For prints with different formulations the printing process is repeated with a formulation adapted to the requirements.

Specifically the air circulation between the nubs and the layers surounding the nubs supports the gas exchange by natural convection and thus contributes to the wearing comfort of the clothes.

A further possibility of the selective print resides in the application of specific designs, such as letters, logos, figures and the like, as well as the admixture of different colours for optical design. Further functions are added to the print by admixture of bacteriostatics or a flame retardant.

A further possibility resides in the application of a print to already at least partially manufactured ready-to-wear-textiles. Thus, the print with the desired specification is applied in the required areas of a textile article, again without loss and with the guarantee, that the seams are not thicker and that the print is selectively applied in an economic and efficient manner.

A further advantage of the process of the invention represent the thus obtained nubs, when these protect a layer susceptible to abrasion, e.g. a layer with a semipermeable coating, against abrasion by means of keeping distance. The prepared nubs are, still in the wet state, applied to the layer which has to be protected and adhered with said layer, or the print is applied directly to the layer to be protected and which contains the semipermeable membrane. The air in the intervals ensures the desired breathability and vapor and moisture exchange.

1. A process for the preparation of temperature regulating surfaces and/or structures on a substrate, characterized in that the surfaces and/or structures are applied to the substrate in the form of a printing process and by the use of a polymeric dispersion with at least one phase change material included therein as a printing substance.

2. A process according to claim 1, characterized in that the printing method is a stencil printing which is carried out by means of rotational stencils.

3. A process according to claim 1, characterized in that the printing method is a stencil printing which is carried out by means of flat stencils.

4. A process according to claim 2 or 3, characterized in that stencils having a wall thickness in the order of 0.6 to 4 mm, preferably 0.6 to 2 mm, are used.

5. A process according to claim 2 or 3, characterized in that stencils with an open surface of at least 25%, preferably at least 35%, are used.

6. A process according to claim 1, characterized in that as a phase change material a crystallizing organic substance, preferably n-paraffine with a melting point between −10 and 65° C. (n-dodecane to n-octacosane) is used.

7. A process according to claim 6, characterized in that a polymeric dispersion is used in which the phase change material introduced is present in a form bound to a porous structure.

8. A process according to claim 6, characterized in that a polymeric dispersion is used in which the phase change material introduced is present in a microencapsulated form.

9. A process according to claim 1, characterized in that by the printing method at least 80 g/m², preferably 100 to 300 g/m² of the phase change material is applied to the substrate.

10. A process according to claim 1, characterized in that a polymeric dispersion with a amount of the phase change material of 30 to 80% of the dried dispersion is used.

11. A process according to claim 1, characterized in that a polymeric dispersion having a dry substance amount of between 200 and 500 g/m² is applied to the substrate.

12. A process according to claim 1, characterized in that a polymeric dispersion is used, the solvent of which is preferably water and the water content of which with respect to the wet dispersion is between 20 and 60%, preferably between 25 und 40%.

13. A process according to claim 1, characterized in that a polymeric dispersion having a viscosity in the range of 80 to 180 dPa·s, preferably in the range of 120 to 160 dpa·s, is used.

14. A process according to claim 1, characterized in that in the polymeric dispersion a polymer is used selected from the group consisting of acrylates, polyurethanes, styrene butadien latices, silicones or blends or copolymerisates of said polymers.

15. A process according to claim 1, characterized in that as a polymeric dispersion a film forming polymer is used which is crosslinkable cold, warm or by UV light, elastic, cold resistant, wash resistant and resistant against dry cleaning.

16. A process according to claim 1, characterized in that to the polymeric dispersion an expanding agent is added which results in the foaming of the printed surfaces.

17. A process according to claim 1, characterized in that the polymeric dispersion is admixed with one or more additions of dies, a bacteriostatic or a flame retardant.

18. A process according to claim 1, characterized in that as a substrate a printable surface in the form of a metal sheet, a metal film or foil, a plastic sheet or film, a foamed material or preferably a textile surface is used.

19. A process according to claim 18, characterized in that as a textile surface preferably an elastic textile fabric, preferably a texture, a knitted fabric or a nonwoven fabric is used.

20. A process according to claim 19, characterized in that as a substrate a textile surface is used which has been finished in a hydrophobic manner.

21. A process according to claim 1, characterized in that the print is applied to the substrate in a manner which only partially covers the area of the substrate.

22. A process according to claim 21, characterized in that by the printing nubs are formed on the substrate.

23. A process according to claim 21, characterized in that the printing is applied to the substrate only partly and at selected sites.

24. A process according to claim 23, characterized in that the printing contours are adapted to a pattern for a manufacture of garmets.

25. A process according to claim 23, characterized in that the print is applied to textiles which have been at least partially manufactured as garmets.

26. A process according to claim 1, characterized in that the print is applied to the substrate in two or more different thicknesses.

27. A process according to claim 1, characterized in that the print is used on the same substrate at least two times successively with different stencils.

28. A process according to claim 1, characterized in that the print is applied in the form of a design, a logo or a letter.

29. A process according to claim 1, characterized in that the print is used in a wet state as an adhesive for a lamination with a cover layer.

30. A process according to claim 29, characterized in that as a cover layer a textile fabric, a knitted fabric or a nonwoven fabric is used.

31. A product, consisting of at least one temperature regulating surface and/or structure on a preferably textile substrate, characterized in that said surface and/or structure has been applied to the substrate by a process according to any of the preceding claims.
